(19) United States
(12) Patent Application Publication
(10) Pub. No.: US 2013/0147806 A1
(43) Pub. Date: Jun. 13, 2013

(54) Comparing Uncertain Options Based on Goals

(71) Applicants: Peter K. Malkin, Yorktown Heights, NY (US); Fan Jing Meng, Haidian Distrit of Beijing (CN); Peri L. Tarr, Yorktown Heights, NY (US); Xin Zhou, Haidian District Beijing (CN)

(72) Inventors: Peter K. Malkin, Yorktown Heights, NY (US); Fan Jing Meng, Haidian Distrit of Beijing (CN); Peri L. Tarr, Yorktown Heights, NY (US); Xin Zhou, Haidian District Beijing (CN)

(73) Assignee: International Business Machines Corporation, Armonk, NY (US)

(21) Appl. No.: 13/323,200

(22) Filed: Dec. 12, 2011

(51) Int. Cl. G06T 11/20

(52) U.S. Cl. 345/440

(57) ABSTRACT

A method including receiving a plurality of probability distributions corresponding to respective competitive goals, receiving an indication of a comparison goal, mapping the comparison goal to a domain independent comparison statistic characteristic, determining a plurality of statistical values of the probability distributions, receiving a selections of a comparison pattern specifying a designed comparison coordination for corresponding ones of the comparison statistic characteristics, converting the plurality of probability distributions into the designed comparison coordination, and displaying the probability distributions in the designed comparison coordination including values of the comparative statistic characteristics of the probability distributions.

### BACKGROUND OF THE INVENTION

1. Technical Field

The present disclosure generally relates to decision-making and more particularly to comparing two or more options.

2. Discussion of Related Art

Random variables or probability distributions are widely used to represent the uncertainty of measurements. For example, a Net Present Value (NPV) probability distribution may be used to measure the value of an on-going project or portfolio in the field of project and portfolio management, whereas a predicted stock price probability distribution may be used to measure the uncertainty of the future stock price in investment management. The comparison of two or more options within these contexts, e.g., to select a stock among a plurality of stocks, presents a difficult problem.

Therefore, a need exists for a system and method for comparing uncertain options.

### BRIEF SUMMARY

According to an embodiment of the present disclosure, a method includes receiving a plurality of probability distributions, determining a plurality of statistical values of the probability distributions according to a pre-defined mapping between a goal and a domain independent comparison statistic characteristic, converting the plurality of probability distributions into a designed comparison coordination according to a plurality of pre-defined comparison patterns, and displaying the probability distributions in the designed comparison coordination including values of the comparative statistic characteristics of the probability distributions.

According to an embodiment of the present disclosure, a method including receiving a plurality of probability distributions corresponding to respective competitive goals, receiving an indication of a comparison goal, mapping the comparison goal to a domain independent comparison statistic characteristic, determining a plurality of statistical values of the probability distributions, receiving a selections of a comparison pattern specifying a designed comparison coordination for corresponding ones of the comparison statistic characteristics, converting the plurality of probability distributions into the designed comparison coordination, and displaying the probability distributions in the designed comparison coordination including values of the comparative statistic characteristics of the probability distributions.

According to an embodiment of the present disclosure, an apparatus includes an input unit receiving a comparison goal and a distribution set of a variable, a statistic selector that selects a statistic corresponding to the comparison goal, a comparator selecting a comparison translation corresponding the statistic, a pattern manager selector selecting a pattern corresponding to the statistic, and a coordination converter determining a value for the statistic for the distribution set of the variable, and comparing the comparison translation with at least one attribute of the comparison goal, wherein the coordination converter outputs data for a visualization of a comparison of the comparison translation and the at least one attribute of the comparison goal.

According to an embodiment of the present disclosure, a computer program product for comprising probability distributions includes a computer readable storage medium, first program instructions to receive a plurality of probability distributions, second program instructions to determine a plurality of statistical values of the probability distributions according to a pre-defined mapping between a goal and a domain independent comparison statistic characteristic, third program instructions to convert the plurality of probability distributions into a designed comparison coordination according to a plurality of pre-defined comparison patterns, and fourth program instructions to display the probability distributions in the designed comparison coordination including values of the comparative statistic characteristics of the probability distributions, wherein the first through fourth program instructions are stored on said computer readable storage medium.

### BRIEF DESCRIPTION OF THE SEVERAL VIEWS OF THE DRAWINGS

Preferred embodiments of the present disclosure will be described below in more detail, with reference to the accompanying drawings:

FIG. 1 is a flow diagram for comparing uncertain options according to an exemplary embodiment of the present disclosure;

FIG. 2 is a system for comparing uncertain options according to an exemplary embodiment of the present disclosure;

FIG. 3 is a listing of mapping rule examples according to an exemplary embodiment of the present disclosure;

FIG. 4 is a presentation of exemplary comparison patterns according to an exemplary embodiment of the present disclosure;

FIGS. 5A-C are probability distributions of respective exemplary projects according to an exemplary embodiment of the present disclosure;

FIG. 6 is a presentation of exemplary characteristics according to an exemplary embodiment of the present disclosure;

FIG. 7 is an exemplary output for a comparison goal for minimizing the NPV risk or relative diversity of NPV according to an exemplary embodiment of the present disclosure;

FIG. 8 is an exemplary output for a comparison goal for maximizing the relative average NPV according to an exemplary embodiment of the present disclosure;

FIG. 9 is an exemplary output for a comparison goal for maximizing the relative NPV at 95% probability according to an exemplary embodiment of the present disclosure;

FIG. 10 is an exemplary output for a comparison goal for minimizing the relative risk of loss of NPV at 5% probability according to an exemplary embodiment of the present disclosure;

FIG. 10 is an exemplary output for a comparison goal for minimizing the relative risk of loss of NPV at 5% probability according to an exemplary embodiment of the present disclosure; and

FIG. 11 is an exemplary output for a comparison goal for maximizing the probability at given NPV $250,000 according to an exemplary embodiment of the present disclosure.

### DETAILED DESCRIPTION

According to an embodiment of the present disclosure, uncertain options may be compared based on a goal. More particularly, random variables may be compared by using a plurality of mapping rules to map a domain dependent comparison goal or concern with domain independent comparison statistic characteristics.

There is a gap between the comparison goals cared about by users and the kinds of statistic characteristic values of random variables. For non-mathematical expert users, it may be difficult to bridge the gap. One difficulty is that different statistic characteristic values (e.g., mean, mode, standard derivation, variance, skewness, etc.) indicate different characteristics of the distribution, which makes it difficult or impossible to use known comparison approaches under different comparison goals.

According to an embodiment of the present disclosure, uncertain options may be compared intuitively based on goals, wherein a comparison goal/concern is translated into statistic characteristics to be compared based on defined domain dependent mapping rules. A domain independent comparison pattern is selected based on mapped statistic characteristics from a set of defined comparison patterns. Information needed to compare the mapped statistic characteristics is determined. A coordination of these random variables is converted into a designed comparison coordination and the random variables are displayed in the designed comparison coordination, which may highlight a comparative statistic characteristics value.

When attempting to choose between two or more options measured by random variables or probability distributions, a competitive goal may be mapped with statistic characteristics of the options. For example, in the exemplary case of making a stock investment decision, the predicted price probability distributions of several stock alternatives may be compared based on a set of competitive goals. The comparison explicitly or implicitly links to a statistic characteristic (e.g., mean, mode, min, max, standard derivation, variance, skewness, etc.) of the compared random variables. For example, two projects' Net Present Value (NPV) may be compared according to the mean for each NPV distribution, or a NPV risk may be compared according to the variance of each NPV distribution.

In the present disclosure, the term “goal” may also include “concern” and the like.

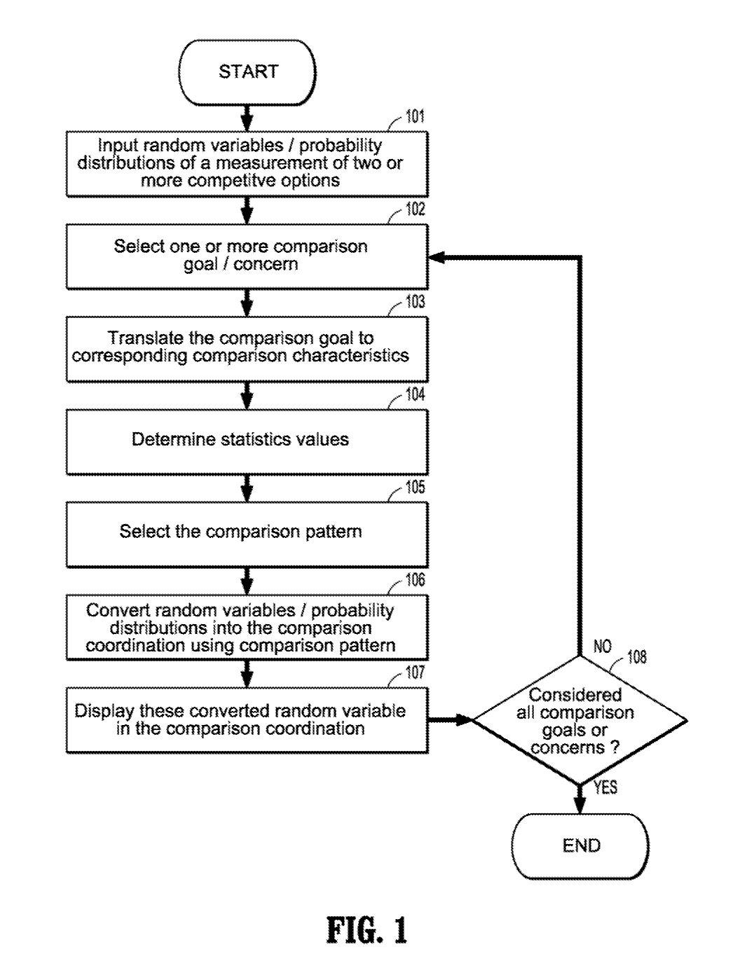

Referring to FIG. 1, random variables/probability distributions of a measurement of two or more competitive options are received (101). A user may select one or more comparison goal for consideration (102). The selected comparison goal is translated to a corresponding comparison characteristic (103). Statistical values for each competitive option are determined using the comparison characteristic (104). A comparison pattern is selected (105). A plurality of comparison patterns may be used to specify a designed comparison coordination for the corresponding statistical values. The random variables/probability distributions are converted into a comparison coordination using the selected pattern and the statistical values (106). The probability distribution coordination of random variables/probability distributions may be converted into the designed comparison coordination for the comparison pattern and a multiple probability distribution may be rendered into the same designed comparison coordination for highlighting comparative statistic characteristics values of these random variables/probability distributions (107). Each goal or concern may be considered iteratively (108).

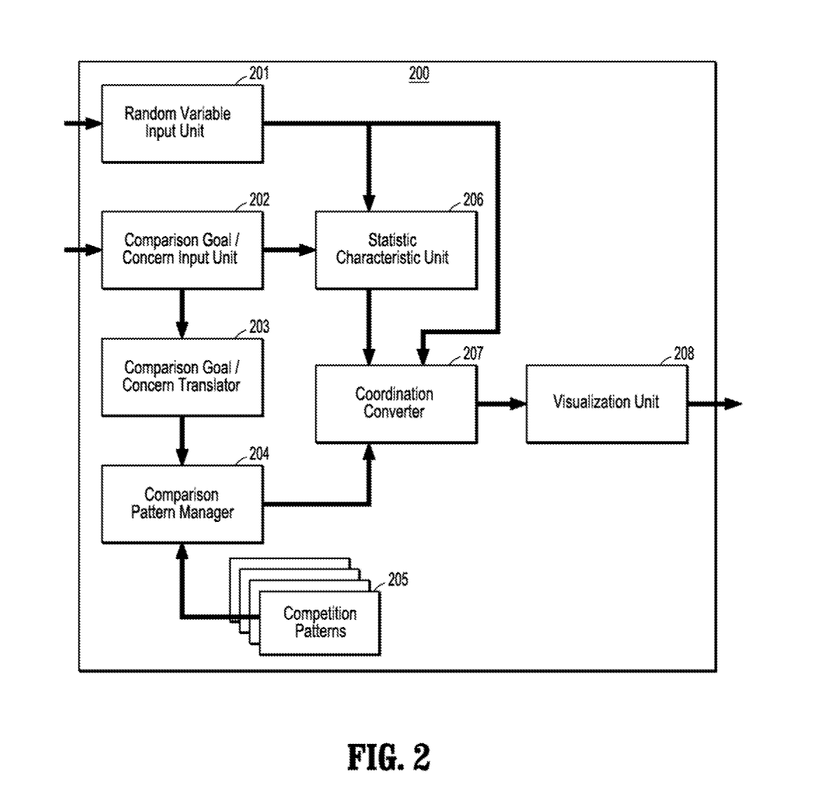

Referring to FIG. 2, a random variable input unit (201) receives the random variables of two or more competitive options and outputs the random variables to a statistics characteristic unit (206) and coordination converter (207). A comparison goal/concern input unit (202) receives the comparison goal/concern and outputs a request to the statistics characteristic unit (206) and the comparison goal/concern to a comparator such as a comparison goal/concern translator (203). The random variable input unit (201) and the comparison goal/concern input unit (202) may be implemented as a single input unit. The statistics characteristic unit (206), having received the random variables from the random variable input unit (201) and the request of the comparison goal/concern input unit (202), determines statistical values and outputs the statistical values to the coordination converter (207). The comparison goal/concern translator (203) outputs comparison characteristics to a comparison pattern manager (204), which has access to a plurality of competition patterns (205). The comparison pattern manager (204) outputs a selected pattern to the coordination converter (207). The coordination converter (207), having received the selected pattern, the statistical values, and random variables outputs data to a visualization unit (208) for determining a visualization of the data as a distribution of curves with comparative values.

In view of FIGS. 1 and 2, a method for comparing uncertain options based on one or more goals may include receiving a plurality of probability distributions, determining a plurality of statistical values of the probability distributions according to a pre-defined mapping between a goal and a domain independent comparison statistic characteristic, converting the plurality of probability distributions into a designed comparison coordination according to a plurality of pre-defined comparison patterns, and displaying the probability distributions in the designed comparison coordination including values of the comparative statistic characteristics of the probability distributions.

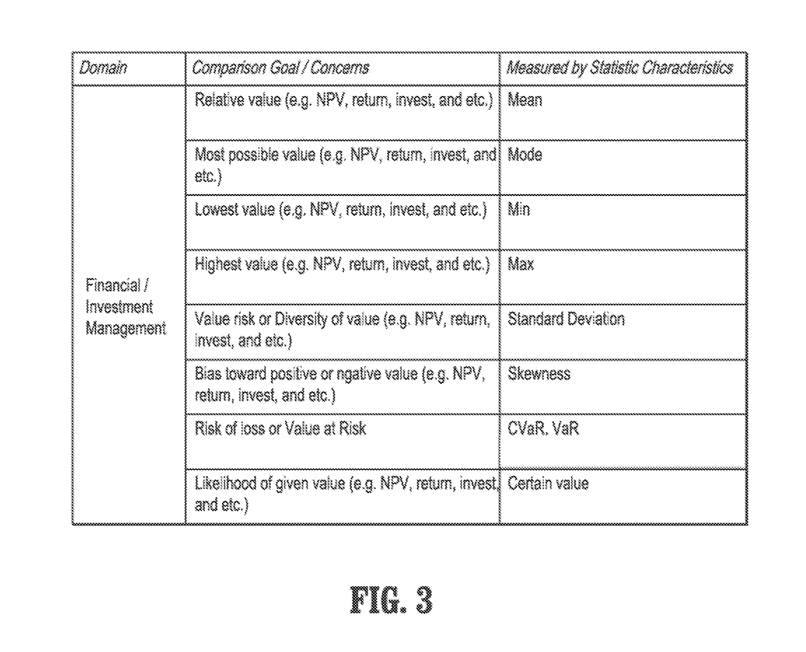

Referring to FIG. 3 showing mapping rule examples in financial/investment management, exemplary comparisons in financial/investment management may include applications for maximizing the relative average value (e.g., NPV, return, invest, and etc.) by comparing the mean of distributions (e.g. NPV, return, invest, and etc.), minimizing the risk of loss or Value at Risk by comparing the VaR(α) or CVaR(α) of distributions (e.g. NPV, return, invest, and etc.), maximizing the likelihood of given value (e.g. NPV, return, invest, and etc.) by comparing the probability of given value, minimizing the relative risk or diversity of value (e.g. NPV, return, invest, and etc.) by comparing the standard derivation, and maximizing the lowest value or highest value (e.g. NPV, return, invest, and etc.) by comparing the minimum or maximum. Other applications are contemplated in financial/investment management and other fields.

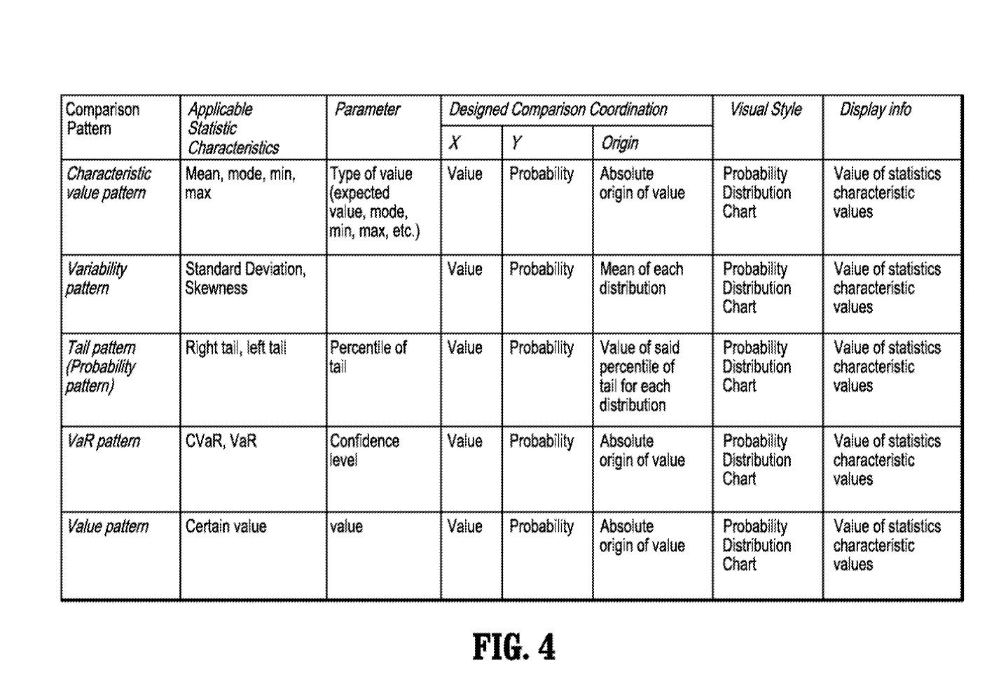

FIG. 4 shows a comparison pattern example.

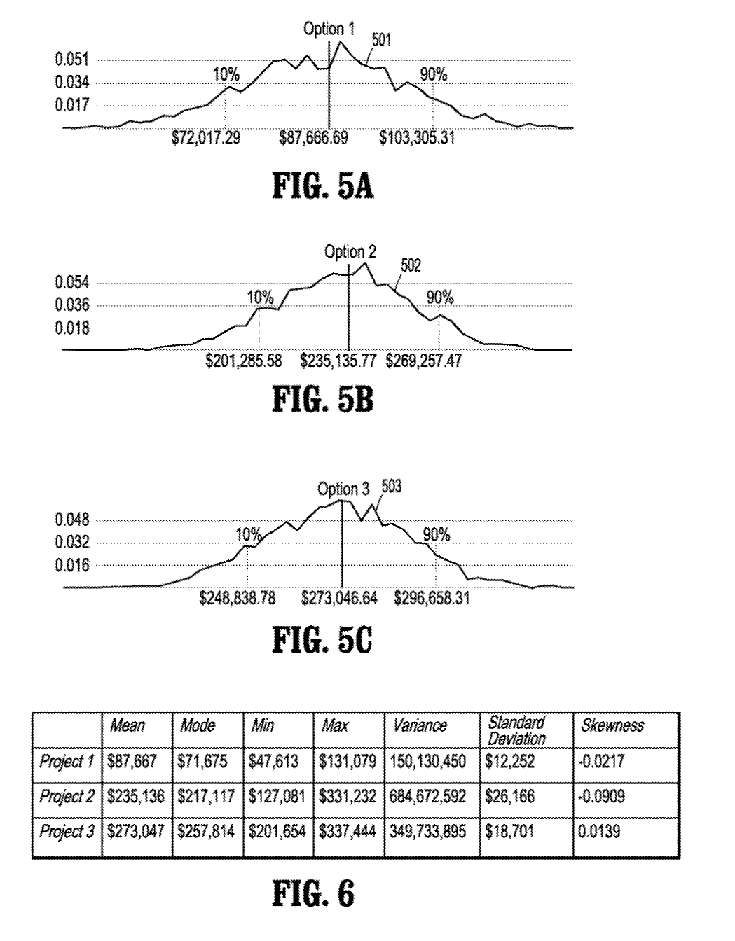

In view of the foregoing, embodiments of the present disclosure will be described in terms of an example including three investment projects. Each project has a random NPV estimation. A decision may be made based on the comparison of the three investment projects. Each investment project is characterized by a probability distribution shown in FIGS. 5A-C, respectively.

According to an embodiment of the present disclosure, statistical characteristic values of the projects may be determined. For example, see FIG. 6, showing mean, mode, minimum, etc., of each project.

Different exemplary comparison goals will now be described.

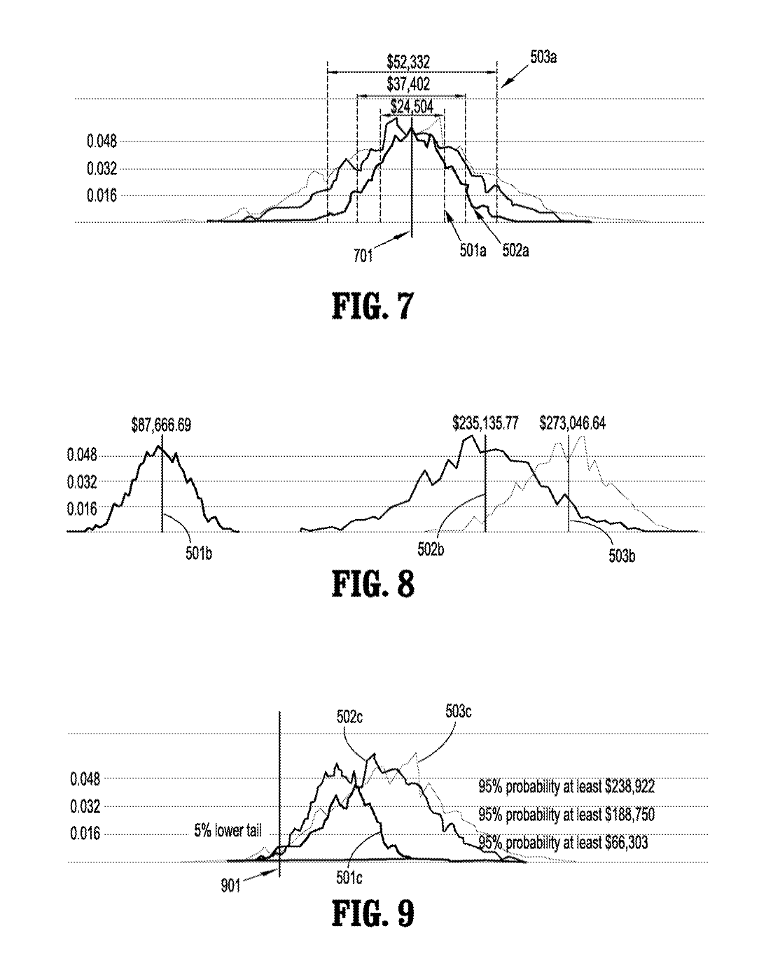

Assuming a comparison goal for minimizing the NPV risk or relative diversity of NPV, a comparative characteristic may be identified, e.g., standard deviation. The comparison pattern of the projects may be matched, for example, according to a variability pattern 501a-503a. Coordination may be converted to a designed comparison coordination, such as a mean 701. An output may include an overlay of the designed comparison coordination as shown in FIG. 7.

Assuming a comparison goal for maximizing the relative average NPV, comparative characteristics may be identified, e.g., mean, and the comparison patterns may be matched, e.g., according to a characteristic value pattern 501b-503b. Coordination may be converted to a designed comparison coordination, e.g., in this example, no conversion is needed. An output may include the comparison patterns matched as shown in FIG. 8.

Assuming a comparison goal for maximizing the relative NPV at 95% probability, the comparative characteristics may be identified, e.g., value of 5% lower tail 901, and the comparison pattern may be matched, e.g., as a tail pattern 501c-503c. Coordination may be converted to a designed comparison coordination, e.g., in this example, the value of 5% lower tail. An output may include an overlay of the designed comparison coordination as shown in FIG. 9.

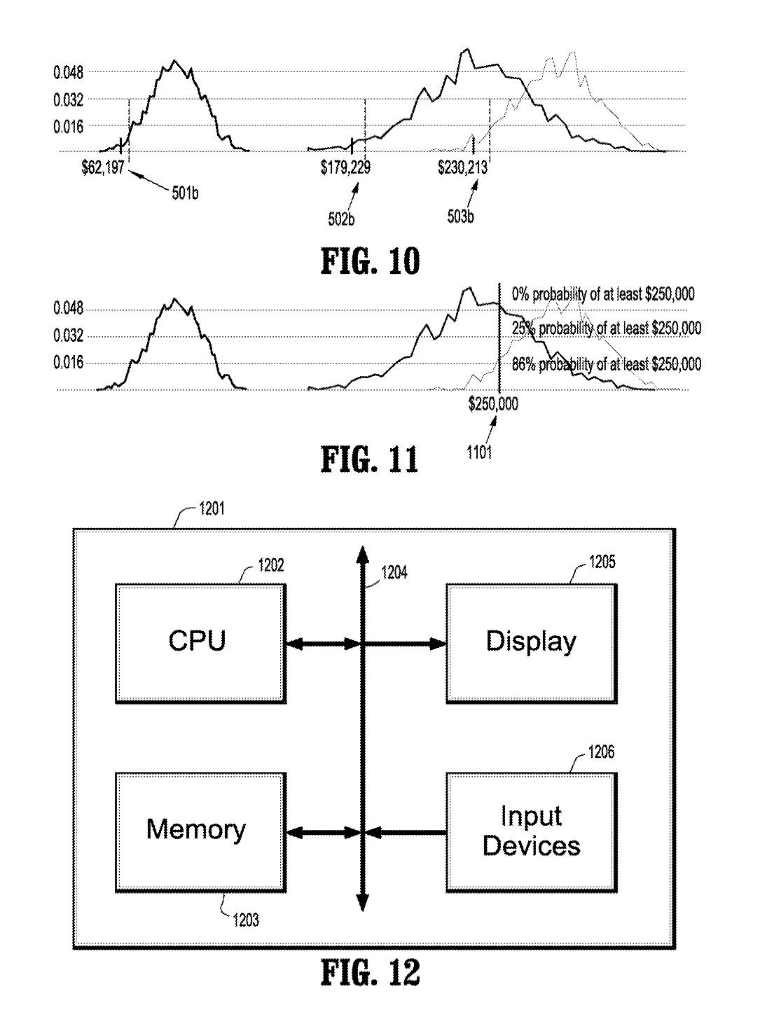

Assuming a comparison goal for minimizing the relative risk of loss of NPV at 5% probability, the comparative characteristics may be identified, e.g., CVaR(5%), and the comparison pattern may be matched, e.g., as a VaR pattern 501d-503d. Coordination may be converted to a designed comparison coordination, e.g., in this example no coordination is needed. An output may include an overlay of the designed comparison coordination as shown in FIG. 10.

Assuming a comparison goal for maximizing the probability at given NPV $250,000, the comparative characteristics may be identified, e.g., probability at value of $250,000 1201, and the comparison pattern may be matched, e.g., as a probability pattern. Coordination may be converted to a designed comparison coordination, e.g., in this example no coordination is needed. An output may include an overlay of the designed comparison coordination as shown in FIG. 11.

The methodologies of embodiments of the disclosure may be particularly well-suited for use in an electronic device or alternative system. Accordingly, embodiments of the present disclosure may take the form of an entirely hardware embodiment or an embodiment combining software and hardware aspects that may all generally be referred to herein as a “processor”, “circuit,” “module” or “system.” Furthermore, embodiments of the present disclosure may take the form of a computer program product embodied in one or more computer readable medium(s) having computer readable program code stored thereon.

Any combination of one or more computer usable or computer readable medium(s) may be utilized. The computer-usable or computer-readable medium may be a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

Computer program code for carrying out operations of embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present disclosure are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

For example, FIG. 12 is a block diagram depicting an exemplary system for comparing random variables. The system 1201 may include a processor 1202, memory 1203 coupled to the processor (e.g., via a bus 1204 or alternative connection means), as well as input/output (I/O) circuitry 1205-1206 operative to interface with the processor 1202. The processor 1202 may be configured to perform one or more methodologies described in the present disclosure, illustrative embodiments of which are shown in the above figures and described herein.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to a multi-core processor or more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although illustrative embodiments of the present disclosure have been described herein with reference to the accompanying drawings, it is to be understood that the disclosure is not limited to those precise embodiments, and that various other changes and modifications may be made therein by one skilled in the art without departing from the scope of the appended claims.

What is claimed is:

1. A method comprising:
receiving a plurality of probability distributions;
determining a plurality of statistical values of the probability distributions according to a pre-defined mapping between a goal and a domain independent comparison statistic characteristic;
converting the plurality of probability distributions into a designed comparison coordination according to a plurality of pre-defined comparison patterns; and
displaying the probability distributions in the designed comparison coordination including values of the comparative statistic characteristics of the probability distributions.

2. The method of claim 1, wherein the goal is a composite of two or more goals.

3. The method of claim 1, wherein the pre-defined mapping between the goal and the domain independent comparison statistic characteristic translates the goal into a statistic characteristic

4. The method of claim 1, wherein the pre-defined comparison patterns specify the designed comparison coordination for corresponding ones of the domain independent comparison statistic characteristics.

5. The method of claim 1, wherein the pre-defined comparison pattern is selected to determine the designed comparison coordination to compare the plurality of probability distributions.

6. The method of claim 1, wherein the comparison goal is a net present value of an investment.

7. The method of claim 1, further comprising a computer program product for comparing the plurality of probability distributions, the computer program product comprising a computer readable storage medium having computer readable program code embodied therewith for performing the method of claim 1.

8. A method comprising:
receiving a plurality of probability distributions corresponding to respective competitive goals;
receiving an indication of a comparison goal;
mapping the comparison goal to a domain independent comparison statistic characteristic;
determining a plurality of statistical values of the probability distributions;
receiving a selection of a comparison patterns specifying a designed comparison coordination for corresponding ones of the comparison statistic characteristics;
converting the plurality of probability distributions into the designed comparison coordination; and
displaying the probability distributions in the designed comparison coordination including values of the comparative statistic characteristics of the probability distributions.

9. The method of claim 8, wherein the comparison goal is a composite of two or more goals.

10. The method of claim 8, wherein the comparison goal is a net present value of an investment.

11. The method of claim 8, wherein the domain independent comparison statistic characteristic is one of a mean, a mode, a minimum, a maximum, a standard derivation, a variance, and a skewness of the probability distributions.

12. The method of claim 8, wherein the comparison goal is a net present value of an investment.

13. The method of claim 8, further comprising a computer program product for comparing the plurality of probability distributions, the computer program product comprising a computer readable storage medium having computer readable program code embodied therewith for performing the method of claim 8.

14. An apparatus comprising:
an input unit receiving a comparison goal and a distribution set of a variable;
a statistic selector that selects a statistic corresponding to the comparison goal;
a comparator selecting a comparison translation corresponding the statistic;
a comparison pattern manager selector selecting a pattern corresponding to the statistic; and
a coordination converter determining a value for the statistic for the distribution set of the variable, and comparing the comparison translation with at least one attribute of the comparison goal, wherein the coordination converter outputs data for a visualization of a comparison of the comparison translation and the at least one attribute of the comparison goal.

15. The apparatus of claim 14, wherein the comparison goal is a net present value of an investment.

16. The apparatus of claim 14, wherein the input unit comprises:
a random variable input unit receiving the distribution set of the variable for at least two competitive options; and
a comparison goal input unit receiving the comparison goal.

17. A computer program product for comprising probability distributions, the computer program product comprising:
a computer readable storage medium;
first program instructions to receive a plurality of probability distributions;
second program instructions to determine a plurality of statistical values of the probability distributions according to a pre-defined mapping between a goal and a domain independent comparison statistic characteristic;
third program instructions to convert the plurality of probability distributions into a designed comparison coordination according to a plurality of pre-defined comparison patterns; and
fourth program instructions to display the probability distributions in the designed comparison coordination including values of the comparative statistic characteristics of the probability distributions,
wherein the first through fourth program instructions are stored on said computer readable storage medium.

18. The computer program product of claim 17, wherein the goal is a composite of two or more goals.

19. The computer program product of claim 17, wherein the pre-defined mapping between the goal and the domain independent comparison statistic characteristic translates the goal into a statistic characteristic

20. The computer program product of claim 17, wherein the pre-defined comparison patterns specify the designed comparison coordination for corresponding ones of the domain independent comparison statistic characteristics.

21. The computer program product of claim 17, wherein the pre-defined comparison pattern is selected to determine the designed comparison coordination to compare the plurality of probability distributions.

22. The computer program product of claim 17, wherein the comparison goal is a net present value of an investment.
